(19) United States
(12) Patent Application Publication
(10) Pub. No.: US 2024/0280716 A1
(43) Pub. Date: Aug. 22, 2024

(54) ACOUSTIC IMAGING USING COLLOCATED PRESSURE AND PRESSURE GRADIENT DATA MEASUREMENTS

(71) Applicant: Exion Technologies, Inc., Houston, TX (US)

(72) Inventor: Nikolaos BERNITSAS, Sugarland, TX (US)

(21) Appl. No.: 18/583,549

(22) Filed: Feb. 21, 2024

Related U.S. Application Data
(60) Provisional application No. 63/447,496, filed on Feb. 22, 2023.

(51) Int. Cl. G01V 1/28; G01V 1/18; G01V 1/20; G01V 1/30; G01V 1/38

(52) U.S. Cl. CPC G01V 1/282; G01V 1/189; G01V 1/301; G01V 1/303; G01V 1/3808; G01V 2001/207; G01V 2210/1293; G01V 2210/1297; G01V 2210/1423; G01V 2210/144; G01V 2210/679

(57) ABSTRACT

Embodiments herein describe techniques for performing acoustic imaging when collocated pressure and three-directional pressure gradient measurements are available. Such measurements become available through the use of a hydrophone and a 3-component geophone or accelerometer when the containing node is neutrally buoyant, or nearly neutrally buoyant, and is coupled to the water column, rather than grounded and thus coupled to the ocean bottom sediments.

### CROSS-REFERENCE TO RELATED APPLICATIONS

This application claims priority to U.S. Provisional Patent Application No. 63/447,496, filed Feb. 22, 2023, the entire content of which is incorporated herein by reference in its entirety.

### BACKGROUND

Traditional ocean bottom seismic data acquisition involves grounded nodes which are equipped with a hydrophone pressure sensor and three geophones (Vₓ,V_{y},V_{z}) or three accelerometers (Aₓ,A_{y},A_{z}) mounted to record the linear motion of the node in the three orthogonal directions (x,y,z) measured in velocity or acceleration, respectively. It is broadly recognized that the pressure sensor is purely responsive to the compressional primary p-waves while the linear motion sensors are responsive to both the compressional p-waves and the shear s-waves, including interface waves such as Scholte waves. It is also broadly recognized that unlike the pressure sensor which measures a scalar wavefield and is insensitive to the polarization of the propagating waves, the linear motion sensors measure a vector wavefield and are sensitive to the polarization of the propagating waves.

The linear motion sensors respond to a propagating elastic wavefield when the node is coupled with the ocean bottom, i.e., it is grounded, and to an acoustic wavefield when the node is coupled to the water column, i.e., it is floating. In both cases, the pressure sensor responds to a propagating acoustic wavefield. Therefore, a floating node is purely responsive to an acoustic wavefield.

When recording in an acoustic medium, as is the case with water, a 3-component accelerometer measures the gradient of the propagating pressure wavefield scaled by −1/ρ where ρ is the density of the sea water. Geophones measure the time integral of such gradient.

The concept of seismic imaging of data obtained from man-made sound sources is schematically represented in FIG. 1. A source 105 near the water surface 110 in the marine environment emits a sound that propagates into the earth in all directions. For a particular direction 115, upon encountering a scatterer 120 at or below the water bottom 125, some of the energy is scattered back in all directions and for a specific direction 130 it is recorded at a sensor node 135 as an upgoing wave. Some of the backscattered energy propagates through a different path 140, reflects at the water surface 110 at a particular direction 145 and is recorded at the receiving sensor node 135 as a downgoing wave. The idea of seismic imaging is to locate the scatterer 120 at its correct spatial position from the known source and receiver positions typically using a plurality of source-receiver pairs.

There are a number of algorithms for pursuing seismic imaging using different solutions to the wave equation, broadly categorized as integral solutions, i.e. Kirchhoff migration (REF), or differential solutions using either the two-way wave equation, i.e. Reverse Time Migration, typically abbreviated as RTM (REF), or the one-way wave equation (REF). To date, as it relates to Ocean Bottom Node (OBN) data, the wavefield used for imaging has been a scalar representation of the recorded pressure in the form of P-Z sum (upgoing) or P-Z difference (downgoing) wavefield (where P refers to pressure and Z refers to the vertical component of the linear motion sensor) as illustrated in FIG. 1.

While the physical field experiment involves one shot at a time recorded on multiple receivers, for input to imaging as it is practiced today the data may be reorganized in ensembles in any number of ways depending on the migration algorithm itself and cost considerations. Integral methods such as Kirchhoff migration image one trace at a time and only depend on the number of source-receiver pairs, so any form of data organization is adequate. One-way wave equation extrapolation methods require all recorded data simultaneously and reorganize the data back and forth into common shot gathers and common receiver gathers for every depth step in the extrapolation process. Finally, two-way wave equation imaging methods such as RTM require the data organized in common shot gathers, i.e., mimicking the way the data was acquired in the field, or the equivalent construct of common receiver gathers.

Because in an OBN survey there are typically more sources than there are receivers, during imaging the data is reorganized as common receiver gathers, i.e., an ensemble of seismic traces recorded by a single receiver from all sources. Using the reciprocity principle, these traces represent what would have been recorded if the source was at the node position and the receivers at the source positions near the free surface. In this context, OBN imaging involves the receiver acting as a source and the sources acting as the receivers. This is referred to as common receiver gather migration.

The Kirchhoff imaging algorithm and the one-wave wave equation extrapolation algorithms implicitly recognize that the scatterer 120 that they intend to image exists below the receiver sensor node 135 and thus they send the energy downwards using either the upgoing wavefield or the downgoing wavefield, in the latter case after repositioning the receiver sensor node 135 at its mirror image location relative to the water surface 110. However, algorithms such as RTM that use the two-way wave equation, propagate the wave in all directions, rather than strictly along the depth axis down. In other words, the RTM algorithm remains incapable of recognizing the directionality (upgoing or downgoing) of the input data and as such it propagates any of these wavefields in both directions rather than in the direction from which the wavefield impinged upon the receiver (reversed in time). The net result is a 3D seismic image with inherently limiting artifacts that are partially mitigated through filtering methods after the data of each grounded seismic node has been separately imaged and prior to the combination of all individual node images into a single 3D subsurface seismic image.

While the preceding discussion pertains to OBN data acquired during a seismic survey with active sources, the same imaging algorithms are used for localizing the sources of passive seismic data, i.e. a powered submersible in the water layer or the cracks generated from the expansion of sequestered CO2 in the subsurface.

Recording of collocated pressure and pressure gradient data offers the opportunity for substantially improving all imaging algorithms referenced above by either using better input scalar wavefield data or through the combined use of all four measured components of the propagating wavefield during imaging.

### SUMMARY

One embodiment described herein includes a method includes recording acoustic data using a floating sensor node that contains a pressure sensor and a motion sensor and processing the acoustic data to obtain a velocity model or to generate an image using two-way wave equation propagation, where a directional receiver back propagates a wave in a reverse direction a pressure wave was received at the floating sensor node when the acoustic data was recorded.

Another embodiment described herein is a non-transitory computer-readable storage medium having computer-readable program code embodied therewith, the computer-readable program code executable by one or more computer processors to perform an operation. The operation receiving acoustic data recorded using a floating sensor node that contains a pressure sensor and a motion sensor and processing the acoustic data to obtain a velocity model or to generate an image using two-way wave equation propagation where a directional receiver back propagates a wave in a reverse direction a pressure wave was received at the floating sensor node when the acoustic data was recorded.

Another embodiment described herein is a non-transitory computer-readable storage medium having computer-readable program code embodied therewith, the computer-readable program code executable by one or more computer processors to perform an operation. The operation includes receiving acoustic data recorded using a floating sensor node that contains a pressure sensor and a three-axis motion sensor, scaling a vertical component measured by the three-axis motion sensor with a combination of two horizontal components and the vertical component measured by the three-axis motion sensor to generate a scaled vertical component, and performing P-Z summation or P-Z subtraction based on the scaled vertical component and a pressure measured by the pressure sensor.

### BRIEF DESCRIPTION OF THE DRAWINGS

FIG. 1 is a schematic diagram of Ocean Bottom Node acquisition illustrating the concept of a receiver detecting energy impinging on it from above or below.

FIG. 2 is a schematic diagram of different floating nodes that can record pressure and pressure gradient data which in turn can be used for improving current imaging methods, according to various embodiments.

FIG. 3 is a schematic diagram that illustrates the different measurements of a grounded OBN node and the components that are used for P-Z summation, according to one embodiment.

FIG. 4 is a schematic diagram of the process of P-Z summation and subtraction using hydrophone pressure and accelerometer pressure gradient data, according to one embodiment.

FIG. 5 is a flowchart for removing the cosine dependence of the vertical component measurement on the angle of propagation away from the vertical direction, according to one embodiment.

FIG. 6 is a flowchart for obtaining P-Z summed data that is accurate for all directions of wave propagation not just the vertical as a modified input to current imaging algorithms, according to one embodiment.

FIG. 7 is a schematic diagram that illustrates how the simultaneous injection of the pressure and the pressure gradient data into the simulation grid result in the correct backpropagation of the pressure field in the direction from which it was received, according to one embodiment.

FIG. 8 is a flowchart for performing seismic imaging using a directional receiver, according to one embodiment.

FIG. 9 illustrates hardware of a computing system, according to one embodiment.

### DETAILED DESCRIPTION

Embodiments herein describe techniques for performing acoustic imaging when collocated pressure and three-directional pressure gradient measurements are available. Such measurements become available through the use of a hydrophone and a 3-component geophone or accelerometer when the containing node is neutrally buoyant, or nearly neutrally buoyant, and is coupled to the water column, rather than grounded and thus coupled to the ocean bottom sediments. The combination of the pressure and the pressure gradient data imply knowledge of the directionality of the propagating acoustic wave and can improve the scalar input data used in all currently practiced imaging algorithms, i.e. Kirchhoff, one-way wave equation extrapolation, RTM, etc. Further, rather than modifying the single scalar wavefield that serves as the input data to any imaging algorithm involving the two-way wave equation, i.e. RTM, as practiced today, the pressure and the pressure gradient measurements can be used in combination to modify the initial conditions of the propagating wavefield, or imaged separately and then combined into a single image, as an implicit way of taking advantage of the embedded directionality of the recorded waves.

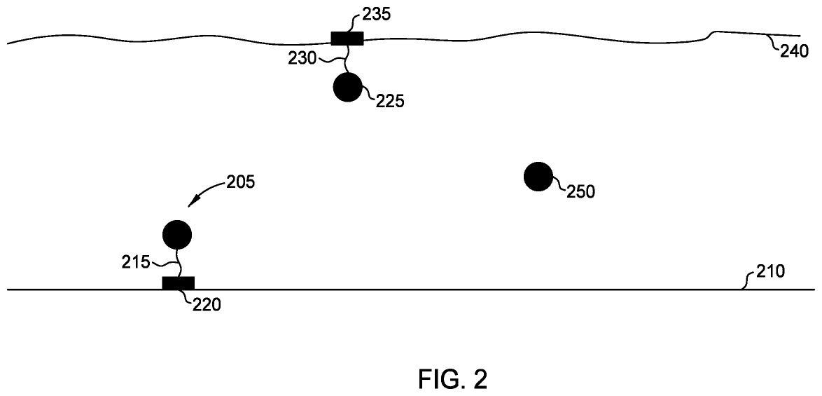

In one embodiment, a receiver can be made directional using data collected from a floating sensor node as shown in FIG. 2. That is, instead of capturing seismic data using seismic nodes that lay on the seafloor, the sensor nodes 205 float above the seafloor 210 (e.g., at least a foot or more). The sensor nodes 205 can be neutrally buoyant or can have a slight positive buoyancy, in which case they use a tether 215 to attach themselves to an anchor 220. The sensor nodes 205 can include a pressure sensor (e.g., a hydrophone) and a three-axis motion sensor (e.g., velocity or acceleration sensors that measure motion in the x, y, and z axes). If the node remains mostly stationary such that it does not experience any motion induced mechanical vibrations and if it is sufficiently decoupled from the ocean floor using a properly engineered tether 215, then the 3-component accelerometer measures the gradient of the propagating pressure wavefield scaled by −1/ρ where ρ is the density of the sea water. Geophones measure the time integral of such gradient.

Given the ability to easily convert data from acceleration (accelerometer) to velocity (geophone) and the other way around via integration or differentiation, respectively, in the following discussion we will use the term accelerometer with the understanding that this could be a geophone whose measurement has been converted from velocity to acceleration.

Similarly, a receiver can be made directional using pressure and pressure gradient data collected from a floating sensor node 225 that uses a tether 230 to attach itself to a buoy 235 at the water surface 240. In this case, the node 225 is neutrally buoyant or can have a slightly negative buoyancy so that it remains suspended in, and coupled to, the water layer. If the node 225 remains mostly stationary, or if along with the buoy it drifts with the currents, such that it does not experience any motion induced mechanical vibrations and if it is sufficiently decoupled from the ocean surface 240 through the use of a properly engineered tether 230, then the 3-component accelerometer measures the gradient of the propagating pressure wavefield scaled by −1/ρ where ρ is the density of the sea water.

A neutrally buoyant but untethered node 250 suspended or drifting in the water layer with the same combination of hydrophone and 3-component accelerometer sensors can also provide the acoustic directionality of a propagating pressure wave.

Any other in water measurement system, towed, self-propelled, dynamically positioned or controlled, etc., that can be mechanically or numerically immunized against interfering mechanical and flow noise, such that it yields collocated pressure and pressure gradient measurements, becomes in effect a simulated floating sensor node and therefore all improvements to imaging methods described herein also apply to data from such a device.

A “floating node” or a “floating sensor node” can include sensor nodes tethered to the ocean bottom, tethered to a buoy, purely suspended or drifting in the water, a submersible that is self-propelled or towed, or simulated from another in water measurement device. For example, a floating sensor node can include any in water measurement device that is towed or otherwise moves through the water for which mechanical vibrations have been removed from the raw measurements so that derived pressure and the pressure gradient measurements obtained by the node are the equivalent of what a stationary floating node would have recorded at the same position. In the floating node, the acoustic directionality measured by the pressure and the 3-component linear sensors is referenced to the coordinate system attached to the frame of the sensors themselves. Depending on how the node is ballasted, the z component of its accelerometer may not be exactly parallel to the vertical direction and the two horizontal components may have arbitrary and varying azimuths. Knowing the orientation of the motion sensors at the time of measurement, routinely provided by a compass and two tilt meters in seismic nodes in use today, allows for a linear transformation of the recorded data to an external user-specified orthogonal coordinate system typically chosen as the vertical and two fixed azimuthally horizontal axes.

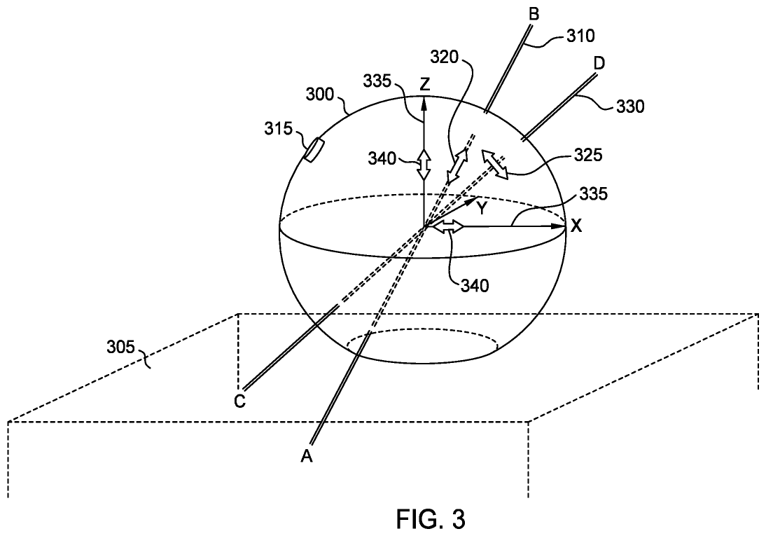

In contrast to FIG. 2 which illustrates sensor nodes that are decoupled from the ocean bottom or the ocean surface, FIG. 3 depicts a sensor node 300 coupled to ocean bottom 305. Assuming a p-wave propagating along the AB line 310, a hydrophone 315 in the node 300 will record the equivalent water pressure scaled by a certain function of the ocean bottom properties at the point of measurement. Further, because a grounded node responds to elastic wave propagation, its linear sensors will simultaneously measure p-waves 320 polarized in parallel to the direction of the AB line 310 and s-waves 325 polarized perpendicularly to the direction of CD line 330. As is the case with the pressure sensor, the linear sensor measurements are also scaled by certain functions of the ocean bottom properties at the point of the measurement. Each of the linear motion sensors on axes (x,y,z) denoted as 335 will therefore capture a mixed signal consisting of the projections 340 of the p-wave vector 320 and the equivalent projections of s-wave vector 325 (not shown to simplify the figure).

Use of the data recorded by a conventional grounded node for reconstructing a 3D image of the subsurface as practiced today requires separation of the p-waves 320 to those propagating from the subsurface to the surface (upgoing) and to those propagating from the surface to the subsurface (downgoing). To date, this has been achieved through a process known as P-Z summation, whereby P refers for pressure and Z refers to the vertical component of the linear motion sensor.

For the grounded node 300, P-Z summation can achieve its separation goal only if the shear s-wave 325 projections on the z component linear motion sensor (V_{z} or A_{z}) of a grounded node 300 are successfully removed so that only p-wave 320 energy is present. This involves the application of an extremely laborious, node location specific, mathematically approximate for all directions other than the true vertical, and typically sub-optimal process.

The present invention using data from a floating node as shown in FIG. 2 rather than a grounded node simplifies and generalizes the concept of P-Z summation as a means of identifying and extracting energy recorded at the node from any arbitrary orientation as input data to acoustic imaging.

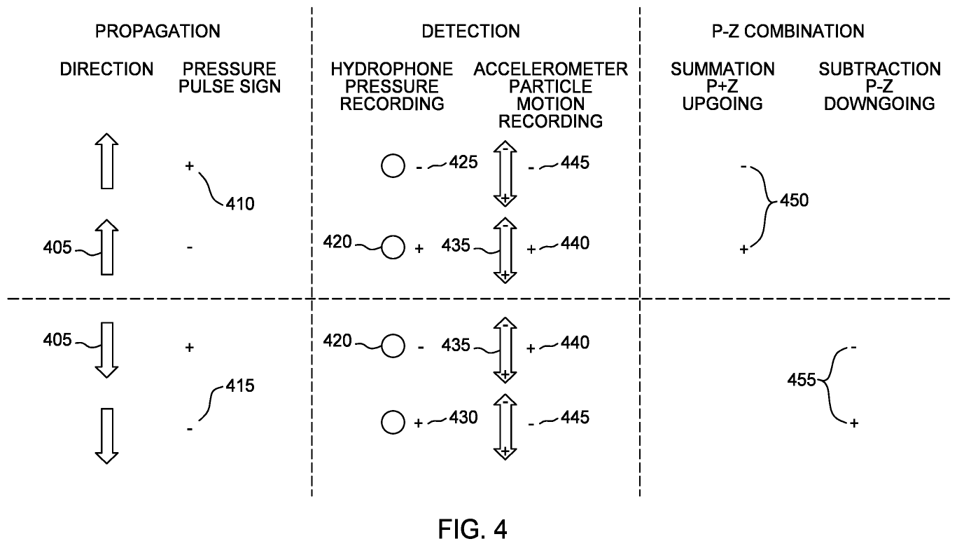

FIG. 4 is a schematic representation of the P-Z summation concept. The arrows 405 on the left column show the direction of propagation of a wave, up or down. This wave may be a positive pulse 410 relative to the hydrostatic pressure or a negative pulse 415. Using the standard convention of the geophysical instrumentation industry, hydrophones 420 record a positive pressure pulse as a negative voltage 425 and a negative pulse as a positive voltage 430, regardless of the direction of the pulse propagation shown by the arrows 405.

The signal recorded by an accelerometer 435 depends on both the sign of the pulses 410, 415 as well as the direction of propagation shown by the arrows 405. In this case, a negative pressure pulse 415 propagating upwards or a positive pressure pulse 410 propagating downwards are recorded as positive signals 440 whereas a positive pressure pulse propagating upward or a negative pressure pulse propagating downwards are recorded as negative signals 445.

Upon summation the output of the hydrophone 420 with the output of the accelerometer 435 only the upgoing signal 450 gets preserved whereas the downgoing signal cancels out. In contrast, upon subtraction of the output of the accelerometer 435 from the output of the hydrophone 420, only the downgoing signal 455 gets preserved while the upgoing signal cancels out. In both cases, the sign of the signal obtained from the P-Z sum and the P-Z difference as shown in signals 450 and 455 matches the sign of the signal as recorded by the hydrophone 420.

### Modified P-Z Summation or Subtraction

In one embodiment, knowledge of the pressure gradient generalizes the P-Z summation as it is currently practiced such that it is exact for all propagating directions not just strictly the vertical.

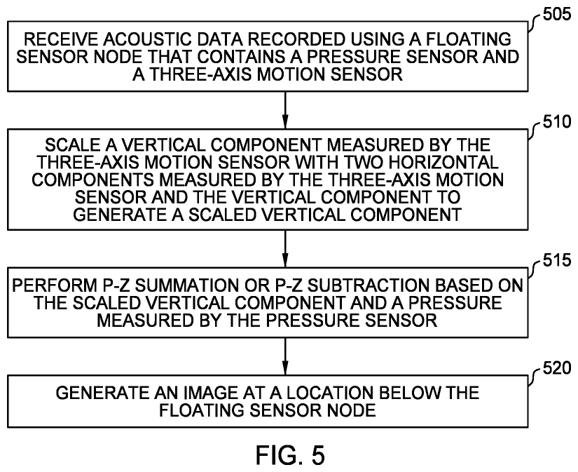

FIG. 5 is a flow chart for removing the cosine dependence of the vertical component measurement on the angle of propagation away from the vertical direction. At block 505, a computing system receives acoustic data recorded using a floating sensor node that contains a pressure sensor and a three-axis motion sensor. The floating sensor can be any of the nodes described in FIG. 2. In one embodiment, the acoustic data measured by the floating sensor node is seismic data for identifying subsurface structures, but this is just one use case of the method described in FIG. 5.

It should be recognized here that while the term three-axis motion sensor (e.g., a 3-component linear sensor) typically implies three orthogonal measurements, such orthogonal measurements can also be numerically derived through transformation of the measurements from any number of three or more motion sensors placed in arbitrary orientations inside the node. Put differently, so long as the relative orientation of the three (or more) motion sensors are known, a transformation can be performed to derive orthogonal measurements, and as such, the embodiments herein are not limited to motion sensors that are orthogonal to each other, or even three motion sensors.

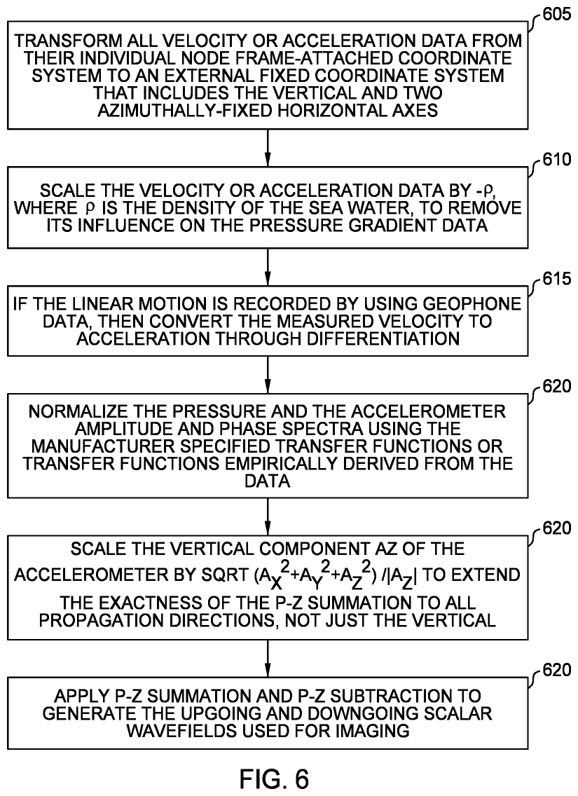

At block 510, a vertical component (e.g., acceleration (A_{z})) measured by the three-axis motion sensor is scaled by a combination of the vertical component (e.g., A_{z}) and the two horizontal components measured by the three-axis motion sensor (e.g., the acceleration measured in the x direction (Aₓ) and the acceleration measured in the y direction (A_{y})). This scaling (which is described in more detail in FIG. 6) removes the cosine dependence of the vertical component measurement on the angle of propagation of the energy as it impinges on the receiver from above or below.

At block 515, the computing system performs P-Z summation or P-Z subtraction using the scaled vertical component and a pressure measured by the pressure sensor (hydrophone). That is, the pressure measured by the pressure sensor on the sensor node and the scaled vertical acceleration determined at block 510 are summed or subtracted to generate angle-compensated wavefields. The P-Z summation or P-Z subtraction is exact for all propagating directions not just strictly the vertical because the pressure and acceleration measurements were obtained using a floating node where the horizontal components (e.g., Aₓ and A_{y}) are strictly responsive to propagating pressure waves and void of any shear wave contamination.

At block 520, the angle-compensated wavefields are used in an imaging algorithm to generate images at a location below the floating sensor node. For example, the images may be of the sub-surface below the location of the sensor node. The embodiments herein are not limited to any particular type of imaging algorithm that receives the wavefields as inputs.

FIG. 6 is a flow chart that shows the process of modifying the P-Z summation so that it is exact for all directions. At block 605, all three components of the linear sensor data are first rotated to a consistent external coordinate system defined by the vertical and two azimuthally fixed horizontal orthogonal axes. At block 610, the data is then scaled by −ρ to remove the dependence of the pressure gradient from the density of the sea water. At block 615, if the gradient data is in velocity, then it is differentiated to turn it into acceleration. Because hydrophones (which measure pressure) and accelerometers are different instruments, they have different transfer functions which should be normalized. Block 620 depicts such normalization whereby the spectra of the transfer functions are provided either from the instrument specs or derived empirically from the data.

At block 625 the vertical component of acceleration A_{z} is scaled by sqrt(Aₓ²₊A_{y}²₊A_{z}²)/|A_{z}| to remove the cosine dependence of the vertical component measurement on the angle of propagation away from the vertical direction. That is, block 625 is one example of scaling a vertical acceleration (A_{z}) measured by the three-axis motion sensor by a combination of the acceleration measured in the z direction (A_{z}), the acceleration measured in the x direction (Aₓ), and the acceleration measured in the y direction (A_{y}) as discussed at block 510 of FIG. 5.

At block 630 the pressure and the scaled A_{z} measurements are summed or subtracted depending on which direction of propagation is of interest for imaging, up or down. The derived P-Z summed, or subtracted, wavefields of FIG. 6 are possible because in a floating node the horizontal components are strictly responsive to propagating pressure waves and are void of any shear wave contamination. These angle-compensated wavefields can then be used as inputs to any of the imaging algorithms, or localization algorithms in the case of passive seismic data, practiced today.

The P-Z summation of FIG. 6 shows how to separate propagating pressure wave energy moving in the positive versus the negative z direction, i.e., it considers two half spaces defined by a horizontal plane that intersects the receiver point and separates energy impinging from above or below. For the floating node data, this concept can be further expanded in an analogous way by considering as an example two half spaces defined by a vertical plane in the y direction intersecting the receiver and using the Aₓ rather than the A_{z} component to separate the pressure energy that propagates in the +x direction vs the −x direction, and similarly for the +y or −y direction. Energy propagation separation in the horizontal direction on an individual receiver basis is impossible with grounded node data. Depending on the target of imaging and the configuration of the sources and receivers in the survey, these wavefields can be used as input data to any of the imaging algorithms, or localization algorithms in the case of passive seismic data, practiced today.

The combination of the horizontal and the two vertical orthogonal planes that go through the receiver point separates the space into 8 subspaces each corresponding to a unique combination of the signed components (±x, ±y, ±z). In a similar approach to isolating upgoing from downgoing waves, and using the combined signs of the measured acceleration components, one can separate waves propagating from any of the eight subspaces to its polar opposite. Depending on the target of imaging and the configuration of the sources and receivers in the survey, these wavefields can be used as input data to any of the imaging algorithms, or localization algorithms in the case of passive seismic data, practiced today.

While the external coordinate reference system discussed above typically involves a vertical and two horizontal azimuthally fixed orthogonal directions on which the recorded data is uniformly transformed to, and which serves as the framework for separating waves propagating in different directions, that is not a limitation. Any other similar external coordinate system of arbitrary orientation can also be used to transform the recorded velocity or acceleration data and in turn separate the waves propagating in its own axes-defined subspaces. In other words, the availability of both pressure and pressure gradient data allows one to accomplish P-Aᵥ summation, or subtraction, where Aᵥ is an arbitrary vector direction. Depending on the target of imaging and the configuration of the sources and receivers in the survey, these wavefields, or any related subset such as wavefields propagating within a cone around Aᵥ, can be used as input data to any of the imaging algorithms practiced today. The concept of P-Aᵥ summation, or subtraction and the use of the derived data similarly applies to data recorded from passive seismic sources.

### Directional Receivers in Back Propagation

Since the measured (Aₓ,A_{y},A_{z}) acceleration components are strictly the projections of the propagating pressure gradient on the three axes, the actual propagation direction at any point in time can be fully determined from the relative ratios of these three components and the pressure. Such direction changes with time as energy impinges on the receiver from different orientations. In current imaging practice, the assumption is that energy can impinge on the receiver from any direction at any time and therefore, in order to obtain a valid image, all possible directions need to be considered when the energy is mapped back into the subsurface.

In another embodiment, knowledge of the exact propagation direction of the impinging wavefield as a function of time is used to improve the image quality of integral imaging applications, such as Kirchhoff migration. In this case, the data is not mapped back from the receiver to the subsurface in all possible directions. Rather, such mapping is limited strictly along, or closely around, the actual specific direction that the wave impinged upon the receiver at any given time and is achieved by a corresponding choice of ray paths, thus reducing the imaging noise.

In another embodiment we use the pressure and pressure gradient data to modify the initial conditions of a two-way wave equation imaging algorithm such as RTM. Because the principle of reciprocity, i.e. the exchangeability of a source with a receiver, applies only for the pressure but not for the pressure gradient, this method uses data organized in common shot gathers rather than common receiver gathers. In this context, the sources are propagated into the subsurface forward in time and the receivers backward in time, i.e., we simulate the wavefield as it existed at different times prior to impinging on the receiver. When the two wavefields coincide in space while representing the same propagation time a scattering point is known to exist.

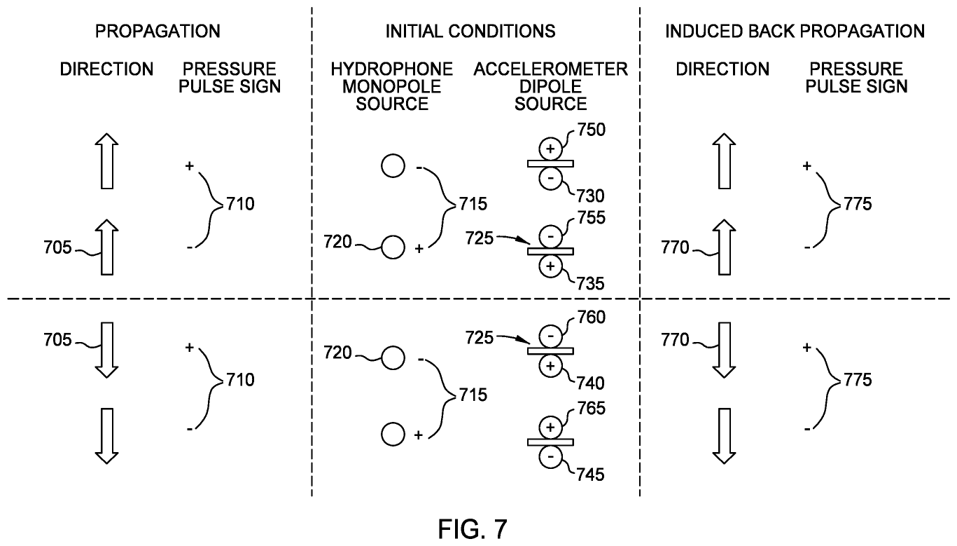

FIG. 7 shows the concept of modifying the initial conditions of RTM at the receiver location such that both the pressure and the pressure gradient are injected simultaneously into the simulation grid and propagated backward in time. To simplify the illustration, only the vertical component of the gradient is shown, but in practice all three components are used. Further, the gradient used here is the output of the workflow after block 620 in FIG. 6 with or without the prior application of block 605. Block 605 unifies the gradient data into a single and common external coordinate system prior to imaging and simplifies the process, but such unification can also happen during imaging if the coordinate system attached to the frame of each node is used instead.

The left part of FIG. 7 illustrates arrows 705 and pressure pulse signs 710 which are a repeat of what is shown in FIG. 4 showing the sign and the direction of propagation of a pressure pulse. During imaging, the recorded pressure 715 is introduced into the simulation grid as a monopole 720, i.e. it radiates at equal strength in all directions as is the current practice. However, in this case a dipole source 725 is introduced into the simulation grid that is centered at the receiver location and represents the data recorded by the linear motion sensor (e.g., an accelerometer). The pole of the dipole source 725 right below the receiver (730, 735, 740, 745) uses the data exactly as recorded by the accelerometer (refer to FIG. 4, elements 440/445). The pole of the dipole source 725 right above the receiver uses the same data but with opposite sign (750, 755, 760, 765). In this configuration, the dipole source 725 propagates the data from the pole above the receiver upwards and the data from the pole below the receiver downwards.

When combined, the pressure and the pressure gradient data cancel on one side of the receiver and only propagate on the other. For example, 750 propagating upwards as a positive wavefield and the corresponding pressure 715 propagating in all directions as a negative wavefield will cancel out, i.e. no propagation takes place in the upward direction. In contrast, 730 propagating downwards as a negative wavefield and the corresponding pressure 715 propagating in all directions as a negative wavefield will reinforce each other in the downward direction shown by the arrow 770. But a negative wavefield propagating in the downward direction corresponds to a positive pressure pulse 775 propagating in the same direction. The net effect is that the combined pressure and accelerometer data introduced into the imaging grid as a monopole and a dipole source, respectively, result in the energy as received by the node implicitly propagating back in the direction from which it was received (compare 710 and 775 along with the corresponding directions shown by the arrows 705 and 770).

When the hydrophone and the three accelerometer wavefields constitute the initial conditions of a two-way wave equation imaging method such as RTM, in the form of a monopole and three orthogonal dipoles that are superimposed at the receiver location, the energy will propagate back strictly in the direction from which it was received, but without limitation as to what that direction is. Further, the combination of the four wavefields in imaging makes redundant the need for steps 625 and 630 in FIG. 6 as both steps happen implicitly using the initial conditions as modified. This is the most physics compliant, complete, and accurate imaging method for propagating acoustic waves. In addition, superior imaging results are achieved without increase in cost relative to common shot gather RTM imaging, as it is only the initial conditions of the grid simulation that are modified, not the simulation itself. In a different embodiment, one can achieve the same result using an albeit more expensive and cumbersome route. Due to the principle of superposition, rather than obtaining an image of shot gathers by combining (or superimposing) the pressure and the pressure gradient wavefields at the receiver location, one can image each of these four wavefields individually and then sum the resulting images into a single volume for each shot at four times the cost.

It should be recognized that one can use the pressure and any one or two components of the pressure gradient, rather than all three, to achieve an approximate solution. For example, the pressure can be combined with the vertical gradient as initial conditions and then imaged as a single field or imaged individually and then summed into a single image.

The exact same concept of modifying the initial conditions of the two-way wave equation in the form of one monopole and three dipoles applies to the back propagation of passive seismic data for the localization of the corresponding seismic source(s).

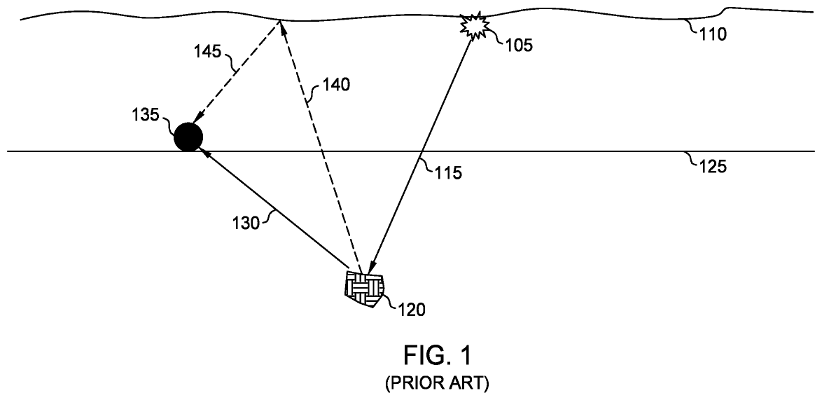

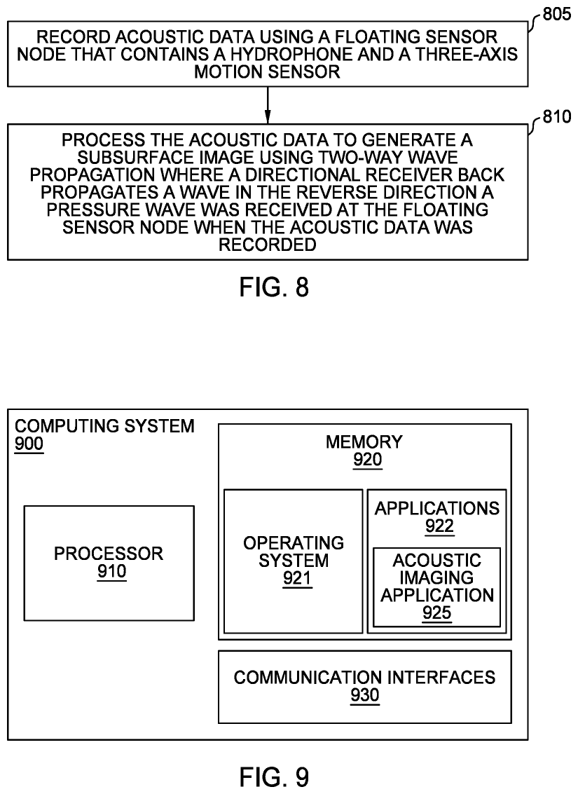

FIG. 8 is a flowchart for performing acoustic imaging using a directional receiver, according to one embodiment. At block 805, a floating sensor node records acoustic data using a hydrophone and a three-axis motion sensor. This is referred to as a detection phase where pressure waves are introduced into the body of water using an active source (e.g., an air gun) or by a passive source (i.e. a powered submersible in the water layer). The pressure waves generated from the source can travel through the subsurface of the Earth and are reflected by different features within the subsurface. These reflections then propagate back into the body of water and are detected by the floating sensor node as shown in FIG. 1. In addition, the pressure waves generated by the source can be recorded during their transmission phase, i.e. when they first go by the receiver as direct rather than reflected waves.

In one example, the sensor node records the pressure of the direct or the reflected wave using the hydrophone as well as the gradient caused by the pressure waves using the three-axis motion sensor (e.g., a three-axis geophone or a three-axis accelerometer). The sensor node may have other sensors that measure other variables that are not discussed in method 800.

The acoustic data can be recorded in memory in the sensor nodes. The sensor nodes can then be retrieved from the water and the data can be downloaded onto a computing device where it is processed. Alternatively, the data could be processed using a computing system on the sensor node.

At block 810, an acoustic data imaging application (e.g., a software application) processes the seismic data to generate an image using two-way wave equation based propagation where a directional receiver back propagates a wave in the reverse direction a pressure wave was received at the floating node when the acoustic data was recorded. In general, two-way wave equation based propagation is an algorithm or technique where pressure waves are emitted from a source and a receiver (which can correspond to the location of the sensor node). The algorithm forward propagates the wave from the source (e.g., moved forward in time) but back propagates the wave from the receiver (e.g., moves backwards in time). In one embodiment, a location where the forward and back propagating waves meet can be the location of an interesting feature in the subsurface which is being imaged. The characteristics of the wave being back propagated by the receiver are determined by the acoustic data that was recorded at block 805.

Instead of identifying an image of a subsurface (i.e., generating a subsurface image), the method 800 can be used to image locations above the floor of the water body or at the floor. In one embodiment, instead of introducing acoustic energy using a seismic source (e.g., an air gun), the method 800 can be used to identify a location of a passive source (e.g., a powered submersible or a marine mammal). The passive source emits acoustic energy that is then detected by the floating sensor node at block 805 and is processed by the two-way wave equation propagation to generate an image that localizes the passive source (e.g., indicates the location of the passive source in the body of water).

In another example, a passive source could be a crack opening below the ocean floor from a migrating carbon sequestration front. The acoustic energy emitted by this source can be detected by the floating sensor node at block 805 and block 810 can be used to generate an image of the crack in the ocean floor. In an analogous way, a passive source could be the wave action at the water surface that propagates through the water layer into the subsurface where it is reflected and can be detected by the floating sensor node at block 805. In this case, block 810 can be used to generate an image of the subsurface and characterize its changes over time. Thus, method 800 can be used to generate images of features or objects of interest that are below the ocean floor, at the ocean floor, or above the ocean floor.

In method 800, rather than treating the receiver as a scalar (e.g., a monopole) in a two-way wave equation imaging method, the method 800 establishes a directional receiver where the wave is emitted in the reverse direction it was received at the sensor node at block 805. This was discussed in detail in FIG. 7. The directional receiver functions as a vector source, obtained through the combination of a pressure monopole and three accelerometer dipoles, that emits a wave only in the opposite direction the pressure wave was received at the sensor node at block 805.

The methods discussed in FIGS. 5-8 can be used to obtain an image (e.g., a subsurface image or an image indicating the location of an object in the body of water) by improving either the input data to imaging or the imaging process itself but can also be used to obtain a subsurface velocity model. For example, Full Waveform Inversion (FWI) uses the 2-way wave equation for wavefield propagation and can similarly deploy modifications to the initial conditions of the wavefield propagation as was demonstrated with RTM. Therefore, the methods employed, and the benefits derived from the use of floating node pressure and pressure gradient data in seismic imaging also apply when deriving a subsurface velocity model.

FIG. 9 illustrates hardware of a computing system 900. The computing system 900 may be a single computing device (e.g., server) or a collection of computing devices (e.g., a data center or cloud computing environment) that performs subsurface imaging. In another embodiment, the computing system 900 can be embedded within a sensor node.

The computing system 900 includes a processor 910, memory 920, and communication interfaces 930. The processor 910 may be any processing element capable of performing the functions described herein. The processor 910 represents a single processor, multiple processors, a processor with multiple cores, and combinations thereof. The communication interfaces 930 facilitate communications between the computing device 900 and other devices. The communications interfaces 930 are representative of wireless communications antennas and various wired communication ports. The memory 920 may be either volatile or non-volatile memory and may include RAM, flash, cache, disk drives, and other computer readable memory storage devices. Although shown as a single entity, the memory 920 may be divided into different memory storage elements such as RAM and one or more hard disk drives.

As shown, the memory 920 includes various instructions that are executable by the processor 910 to provide an operating system 921 to manage various functions of the computing device 900 and one or more applications 922 to provide various functionalities, which include one or more of the functions and functionalities described in the present disclosure. In this case, the applications 922 includes an acoustic imaging application 925 which can perform the various imaging techniques discussed above (e.g., Kirchhoff migration, Reverse Time Migration, one-way wave equation based extrapolation, obtaining a subsurface velocity model, and the like). In one embodiment, the acoustic imaging application 925 can perform some of the blocks described in FIGS. 5, 6, and 8 and functions of the other Figures.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

What is claimed is:

1. A method comprising:
recording acoustic data using a floating sensor node that contains a pressure sensor and a motion sensor; and
processing the acoustic data to obtain a velocity model or to generate an image using two-way wave equation propagation, where a directional receiver back propagates a wave in a reverse direction a pressure wave was received at the floating sensor node when the acoustic data was recorded.

2. The method of claim 1, wherein processing the acoustic data further comprises one of:
superimposing a monopole corresponding to the pressure sensor and at least one dipole associated with the motion sensor at a location of the directional receiver when performing the two-way wave equation propagation, or
imaging the monopole and the least one dipole individually to generate resulting images, and then summing the resulting images.

3. The method of claim 2, wherein processing the acoustic data further comprises:
orienting the dipole to have a first orientation where a negative side faces up and a positive side faces down in response to a first output of the motion sensor and orientating the dipole to have a second orientation that is flipped relative to the first orientation in response to a second output of the motion sensor.

4. The method of claim 3, wherein an output emitted by one of the negative side or the positive side of the dipole cancels with an output emitted by the monopole while the other side of the dipole combines with the output emitted by the monopole.

5. The method of claim 1, wherein motion sensor is a three-axis motion sensor, wherein processing the acoustic data further comprises:
superimposing a monopole corresponding to the pressure sensor and three dipoles associated with the three-axis motion sensor at a location of the directional receiver when performing the two-way wave equation propagation.

6. The method of claim 5, wherein an output emitted by one of a negative side or a positive side of each of the three dipoles cancels with an output emitted by the monopole while the other side of each of the three dipoles combines with the output emitted by the monopole.

7. The method of claim 1, wherein the two-way wave equation propagation comprises forward propagating a second wave from a source in parallel with the directional receiver back propagating the wave.

8. The method of claim 1, wherein the floating sensor node is neutrally buoyant or has a slight positive buoyancy.

9. The method of claim 8, wherein the floating sensor node is tethered to an anchor.

10. The method of claim 1, wherein the floating sensor node comprises an in water measurement device that moves through the water and where mechanical vibrations and flow noise have been removed from the acoustic data obtained by the floating sensor node.

11. The method of claim 1, wherein the image can include a subsurface image, an image of a feature at a floor of a body of water, or an image that indicates a location of an object in the body of water.

12. A non-transitory computer-readable storage medium having computer-readable program code embodied therewith, the computer-readable program code executable by one or more computer processors to perform an operation, the operation comprising:
receiving acoustic data recorded using a floating sensor node that contains a pressure sensor and a motion sensor; and
processing the acoustic data to obtain a velocity model or to generate an image using two-way wave equation propagation where a directional receiver back propagates a wave in a reverse direction a pressure wave was received at the floating sensor node when the acoustic data was recorded.

13. The non-transitory computer-readable storage medium of claim 12, wherein processing the acoustic data further comprises:
superimposing a monopole corresponding to the pressure sensor and at least one dipole associated with the motion sensor at a location of the directional receiver when performing the two-way wave equation propagation.

14. The non-transitory computer-readable storage medium of claim 13, wherein processing the acoustic data further comprises:
orienting the dipole to have a first orientation where a negative side faces up and a positive side faces down in response to a first output of the motion sensor and orientating the dipole to have a second orientation that is flipped relative to the first orientation in response to a second output of the motion sensor.

15. The non-transitory computer-readable storage medium of claim 14, wherein an output emitted by one of the negative side or the positive side of the dipole cancels with an output emitted by the monopole while the other side of the dipole combines with the output emitted by the monopole.

16. The non-transitory computer-readable storage medium of claim 12, wherein motion sensor is a three-axis motion sensor, wherein processing the acoustic data further comprises one of:
superimposing a monopole corresponding to the pressure sensor and three dipoles associated with the three-axis motion sensor at a location of the directional receiver when performing the two-way wave equation propagation, or
imaging the monopole and the least one dipole individually to generate resulting images, and then summing the resulting images.

17. A non-transitory computer-readable storage medium having computer-readable program code embodied therewith, the computer-readable program code executable by one or more computer processors to perform an operation, the operation comprising:
receiving acoustic data recorded using a floating sensor node that contains a pressure sensor and a three-axis motion sensor;
scaling a vertical component measured by the three-axis motion sensor with a combination of two horizontal components and the vertical component measured by the three-axis motion sensor to generate a scaled vertical component; and
performing P-Z summation or P-Z subtraction based on the scaled vertical component and a pressure measured by the pressure sensor.

18. The non-transitory computer-readable storage medium of claim 17, wherein scaling the vertical component removes a cosine dependence of the vertical component on any angle of propagation of energy that impinges on the floating sensor node from above or below the floating sensor node.

19. The non-transitory computer-readable storage medium of claim 18, wherein the cosine dependence is removed by scaling the vertical component using the following operation:
sqrt(Aₓ²₊A_{y}²₊A_{z}²)/|A_{z}|

wherein A_{z} is vertical acceleration and Ax and A_{y} are horizontal accelerations measured by the three-axis motion sensor.

20. The non-transitory computer-readable storage medium of claim 17, wherein the two horizontal components are strictly responsive to propagating pressure waves and are void of any shear wave contamination, as is the vertical component.

21. The non-transitory computer-readable storage medium of claim 17, wherein the floating sensor node is neutrally buoyant or has a slight positive buoyancy.

22. The non-transitory computer-readable storage medium of claim 21, wherein the floating sensor node is tethered to an anchor.

23. The non-transitory computer-readable storage medium of claim 17, wherein the floating sensor node comprises an in water measurement device that moves through the water and where mechanical vibrations have been removed from the acoustic data obtained by the floating sensor node.
